(19) United States
(12) Patent Application Publication
(10) Pub. No.: US 2025/0059424 A1
(43) Pub. Date: Feb. 20, 2025

(54) NUCLEATION AGENT

(71) Applicant: NOSTROMO LTD., Even-Yehuda (IL)

(72) Inventors: Lior MARELI, Rehovot (IL); Yaron BEN NUN, Even-Yehuda (IL); Ido BRASLAVSKY, Ness Ziona (IL)

(21) Appl. No.: 18/721,920

(22) PCT Filed: Dec. 22, 2022
(86) PCT No.: PCT/IL2022/051383

§ 371 Date: Jun. 20, 2024

Related U.S. Application Data
(60) Provisional application No. 63/292,519, filed on Dec. 22, 2021.

(51) Int. Cl. C09K 5/06; F28D 20/00

(52) U.S. Cl. CPC C09K 5/063; F28D 20/0056

(57) ABSTRACT

A Thermal Storage Unit (TSU) including a Phase Change Material (PCM). and a nucleating temperature elevating nucleation agent in contact with the PCM. wherein the nucleation agent includes a Polyamide (PA) polymer. A method of freezing phase change fluid. the method including providing a phase change fluid. and cooling the phase change fluid until the phase change fluid nucleates, wherein the phase change fluid includes a mix of a phase change material (PCM) and a nucleation agent. and the nucleation agent includes a Polyamide (PA) polymer. A method of producing phase change fluid. the method including providing water. adding a Polyamide (PA) polymer material as a nucleation agent to the water, thereby producing an elevated nucleation temperature mixture with a nucleation temperature higher than the nucleation temperature of water without nucleation agent. Related apparatus and methods are also described.

### NUCLEATION AGENT

FIELD AND BACKGROUND OF THE INVENTION

The present invention, in some embodiments thereof, relates to methods and materials used for affecting nucleation temperature in phase change materials.

For example, adding a nucleating agent to water raises the initial freezing temperature of the water. The initial freezing temperature is sometimes called a nucleation temperature.

### SUMMARY OF THE INVENTION

The present disclosure, in some embodiments thereof, relates to using a nucleation material for raising nucleation temperature of a phase change material.

Some non-limiting examples of the phase change material include a fluid, for example water, in a thermal storage unit, or in a capsule within a thermal storage unit.

According to an aspect of some embodiments of the present disclosure there is provided a Thermal Storage Unit (TSU) including a Phase Change Material (PCM), and a nucleating temperature elevating nucleation agent in contact with the PCM, wherein the nucleation agent includes a Polyamide (PA) polymer.

According to some embodiments of the disclosure, the nucleation agent is mixed with the PCM.

According to some embodiments of the disclosure, the PCM includes water.

According to some embodiments of the disclosure, the nucleation agent includes a granulated Polyamide (PA) polymer.

According to some embodiments of the disclosure, the granulated Polyamide (PA) polymer has a grain size up to 5 millimeters in diameter.

According to some embodiments of the disclosure, the granulated Polyamide (PA) polymer has a grain size of between 0.01 and 1.5 millimeters in diameter.

According to some embodiments of the disclosure, the nucleation agent includes a Polyamide (PA) polymer filament.

According to some embodiments of the disclosure, the nucleation agent includes a tangled filament.

According to some embodiments of the disclosure, the nucleation agent includes a Polyamide (PA) polymer sponge.

According to some embodiments of the disclosure, the TSU includes a capsule, the capsule including the PCM and the nucleation agent in contact with the PCM.

According to an aspect of some embodiments of the present disclosure there is provided a method of freezing phase change fluid, the method including providing a phase change fluid, and cooling the phase change fluid until the phase change fluid nucleates, wherein the phase change fluid includes a mix of a phase change material (PCM) and a nucleation agent, and the nucleation agent includes a Polyamide (PA) polymer.

According to some embodiments of the disclosure, the PCM includes water.

According to some embodiments of the disclosure, the nucleating agent is ground PA.

According to some embodiments of the disclosure, the ground PA includes a grain size of up to 5 mm.

According to an aspect of some embodiments of the present disclosure there is provided a method of producing phase change fluid, the method including providing water, adding a Polyamide (PA) polymer material as a nucleation agent to the water, thereby producing an elevated nucleation temperature mixture with a nucleation temperature higher than the nucleation temperature of water without nucleation agent.

According to some embodiments of the disclosure, the water and the Polyamide (PA) polymer material are placed in a capsule for use in a Thermal Storage Unit (TSU).

According to some embodiments of the disclosure, the water is provided to a capsule for use in a Thermal Storage Unit (TSU) and the (PA) polymer material is added to the capsule.

According to some embodiments of the disclosure, including mixing the water and the PA polymer material.

According to some embodiments of the disclosure, the PA polymer material is granulated PA polymer material.

According to some embodiments of the disclosure, grains of the granulated PA polymer material have a grain size up to 5 millimeters in diameter.

According to an aspect of some embodiments of the present disclosure there is provided a method of raising a freezing temperature of water, the method including providing water, adding a Polyamide (PA) polymer material to the water, thereby producing an elevated freezing temperature mixture with a freezing temperature higher than the freezing temperature of water under similar conditions.

According to some embodiments of the disclosure, the method includes mixing the water and the PA polymer material.

According to some embodiments of the disclosure, the PA polymer material is granulated PA polymer material.

According to some embodiments of the disclosure, grains of the granulated PA polymer material have a grain size up to 5.0 millimeters in diameter.

According to some embodiments of the disclosure, the mixture is allowed a specific period of time to absorb at least some of the water before being used as an elevated freezing temperature mixture.

According to an aspect of some embodiments of the present disclosure there is provided a Thermal Storage Unit (TSU) including a phase change fluid, and a freezing temperature elevating nucleating agent in contact with the phase change fluid.

According to some embodiments of the disclosure, the freezing temperature elevating nucleating agent is mixed with the phase change fluid.

According to some embodiments of the disclosure, the phase change fluid includes water. According to some embodiments of the disclosure, the freezing temperature elevating nucleating agent includes a Polyamide (PA) polymer.

According to some embodiments of the disclosure, the freezing temperature elevating nucleating agent includes a granulated Polyamide (PA) polymer.

According to some embodiments of the disclosure, the granulated Polyamide (PA) polymer has a grain size up to 5.0 millimeters in diameter.

According to some embodiments of the disclosure, the TSU includes capsules, the capsule including the phase change fluid and the freezing temperature elevating nucleating agent in contact with the phase change fluid.

Unless otherwise defined, all technical and/or scientific terms used herein have the same meaning as commonly understood by one of ordinary skill in the art to which the invention pertains. Although methods and materials similar or equivalent to those described herein can be used in the practice or testing of embodiments of the invention, exemplary methods and/or materials are described below. In case of conflict, the patent specification, including definitions, will control. In addition, the materials, methods, and examples are illustrative only and are not intended to be necessarily limiting.

### BRIEF DESCRIPTION OF THE SEVERAL VIEWS OF THE DRAWING(S)

Some embodiments of the invention are herein described, by way of example only, with reference to the accompanying drawings. With specific reference now to the drawings in detail, it is stressed that the particulars shown are by way of example and for purposes of illustrative discussion of embodiments of the invention. In this regard, the description taken with the drawings makes apparent to those skilled in the art how embodiments of the invention may be practiced.

In the drawings:

FIG. 1A is a simplified flow chart illustration of a method of changing a nucleating temperature of water, as a phase change material (PCM), by adding a polyamide (PA) polymer material as a nucleation agent, according to an example embodiment;

FIG. 1B is a simplified block diagram illustration of a Thermal Storage Unit (TSU) which contains water, as a PCM, and PA polymer material as a nucleation agent, according to an example embodiment;

FIG. 1C is a simplified block diagram illustration of a TSU which contains capsules which contain water, as a PCM, and PA polymer material as a nucleation agent, according to an example embodiment;

FIG. 2 is a graph showing a temperature of a PCM, in this example water, over time, when the PCM does not have a nucleation agent added;

FIG. 3 is a graph showing a temperature of a PCM, in this example water, over time, when the PCM does have a nucleation agent, in this example a Polyamide (PA) polymer, added, according to an example embodiment;

FIG. 4 is a graph showing a comparison, over time, of temperature of water with a nucleation agent added to water without nucleation agent added, according to an example embodiment;

FIG. 5 is a graph showing a comparison, over time, of temperature of water with a nucleation agent added to water without a nucleation agent added, according to an example embodiment; and

FIG. 6 is a simplified flowchart illustration of a method of freezing phase change fluid according to an example embodiment.

### DESCRIPTION OF SPECIFIC EMBODIMENTS OF THE INVENTION

The present invention, in some embodiments thereof, relates to methods and materials used for affecting nucleation temperature in phase change materials.

### Introduction

The present disclosure, in some embodiments thereof, relates to adding a nucleation agent, or nucleation material, to a phase change material (PCM), the nucleation material selected for raising temperature of the initial freezing stage of the PCM. The term “nucleation agent” in all its grammatical forms is used throughout the present specification and claims interchangeably with the term “nucleation material” and its corresponding grammatical forms. In some embodiments, the PCM can be, by way of a non-limiting example, a fluid, for example water. In some embodiments the PCM may optionally be within a thermal storage unit, and/or within a capsule within the thermal storage unit.

### Overview

An aspect of some embodiments relates to using a nucleation material for raising the initial freezing temperature of water acting as a phase change material. Freezing water can absorb plenty of energy, and the ice (frozen water) can serve to provide thermal energy, e.g., to cool cooling systems, during a period of otherwise unavailable thermal energy, or periods of more-expensive thermal energy.

### Properties of the Nucleation Material

In some embodiments, the nucleation material has one or more of the following properties:

The nucleation material potentially withstands multiple cycles of phase change. In some embodiments the nucleation material potentially withstands multiple cycles of freezing and thawing. Such a property potentially enables a system to use the PCM over and over again, without requiring replacement and/or maintenance over hundreds or even thousands of phase change, e.g . . . freeze and thaw cycles.

The nucleation material can potentially absorb PCM, or be absorbed by the PCM, for example water, and still withstand multiple cycles of freezing and thawing, so as not to require replacement or maintenance over hundreds or even thousands of freeze and thaw cycles.

In some embodiments, the nucleation material potentially enables water mixed with the nucleation material to nucleate at a temperature above −3 degrees Celsius. For example, in an example case where pure water is cooled, super-cooled water (H₂O) can be nucleated at −6.5 degrees Celsius. When a nucleation agent is added to the water the nucleation temperature of the water can rise higher, for example to −3.0 degrees Celsius.

When the nucleation material raises the nucleation temperature of PCM (e.g., water), a system for freezing the PCM (water) is not required to reach lower temperatures before starting to store the energy in the phase change. It is pointed out that 1 gram of water absorbs energy on the order of one calorie per degree Celsius, while freezing water absorbs energy on the order of 80 calories for the phase change (freezing). The further water is cooled below phase change temperature before it starts to freeze, the greater the engineering challenge to cool it, and potentially greater energy losses are expected.

Before explaining at least one embodiment of the invention in detail, it is to be understood that the invention is not necessarily limited in its application to the details of construction and the arrangement of the components and/or methods set forth in the following description and/or illustrated in the drawings and/or the Examples. The invention is capable of other embodiments or of being practiced or carried out in various ways.

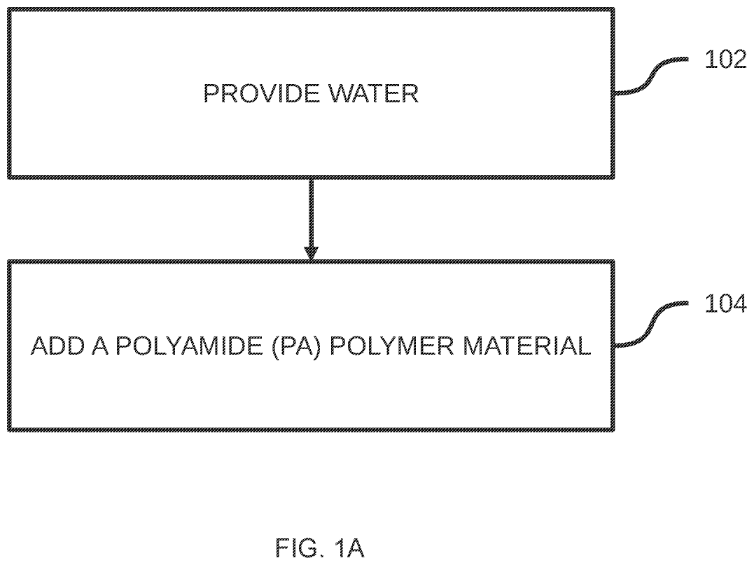

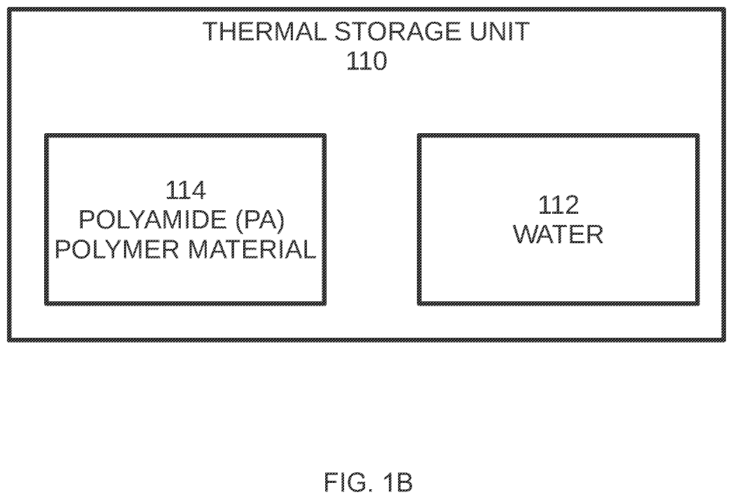

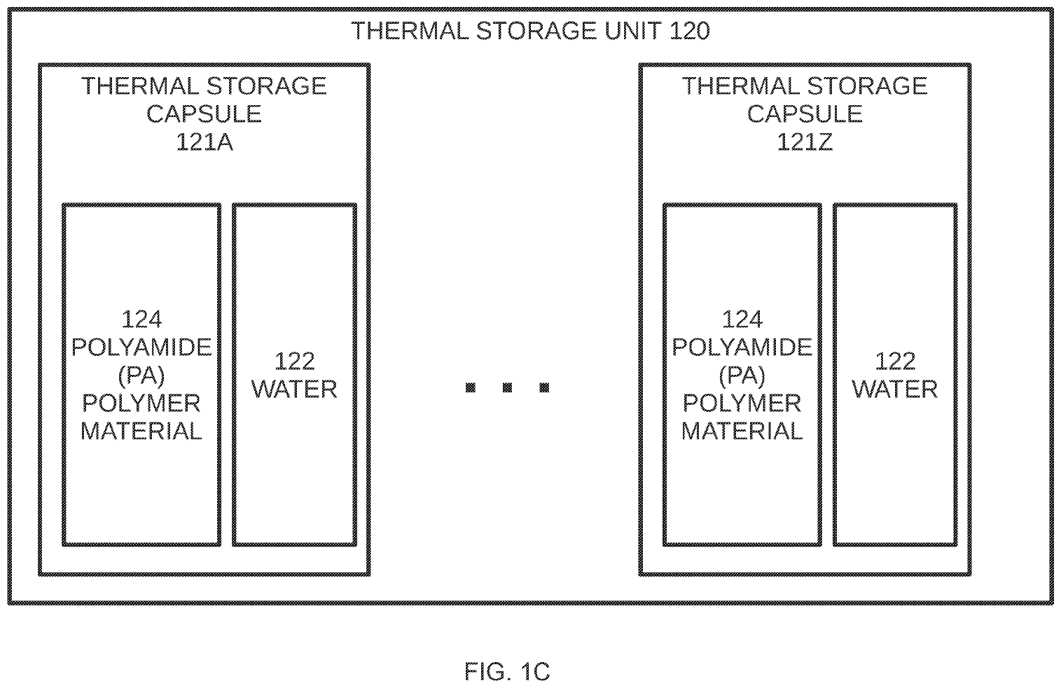

Reference is now made to FIG. 1A, which is a simplified flowchart illustration of a method of changing a nucleating temperature of water, as a phase change material (PCM), by adding a polyamide (PA) polymer material as a nucleation agent, according to an example embodiment.

FIG. 1A shows an example of a method of raising a nucleation temperature of water.

The method shown in FIG. 1A includes:
providing water (102);
adding a Polyamide (PA) polymer material to the water (104), thereby producing an elevated nucleation temperature mixture with a nucleation temperature higher than the nucleation temperature of water under similar conditions.

Reference is now made to FIG. 1B, which is a simplified block diagram illustration of a Thermal Storage Unit (TSU) which contains water, as a PCM, and PA polymer material as a nucleation agent, according to an example embodiment.

FIG. 1B shows an example of TSU constructed to contain a PCM adapted to raise a nucleation temperature of the PCM by virtue of including a nucleation agent.

FIG. 1B shows a TSU 110 which contains water 112 and polyamide (PA) polymer material as a nucleation agent.

Reference is now made to FIG. 1C, which is a simplified block diagram illustration of a TSU which contains capsules which contain water, as a PCM, and PA polymer material as a nucleation agent, according to an example embodiment.

FIG. 1C shows an example of a TSU constructed to contain thermal storage capsules which each contain a PCM adapted to raise a nucleation temperature of the PCM by virtue of including a nucleation agent.

FIG. 1C shows a TSU 120 which contains any number of thermal storage capsules 121. each of which contain water 112 and polyamide (PA) polymer material as a nucleation agent. By way of a non-limiting example, two thermal storage capsules 121A and 121Z are shown, although any number from one capsule on up is contemplated.

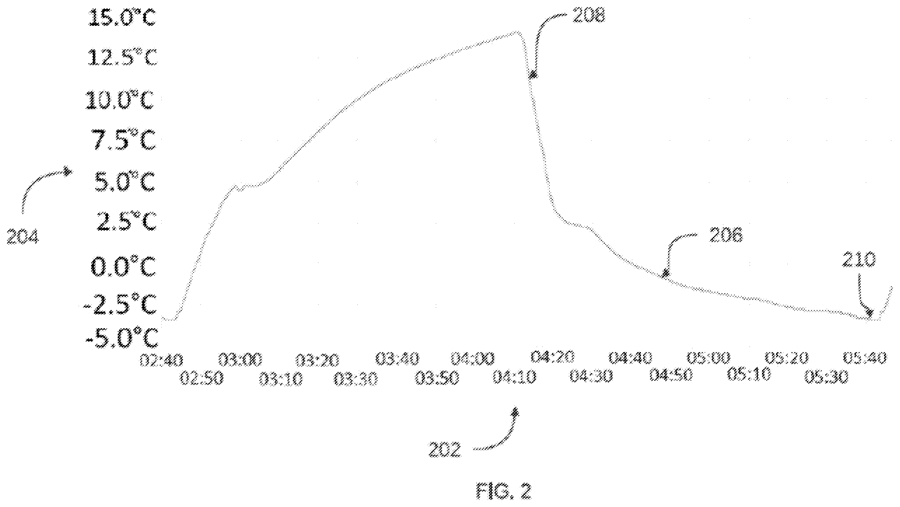

Reference is now made to FIG. 2, which is a graph showing a temperature of a PCM, in this example water, over time, when the PCM does not have a nucleation agent added.

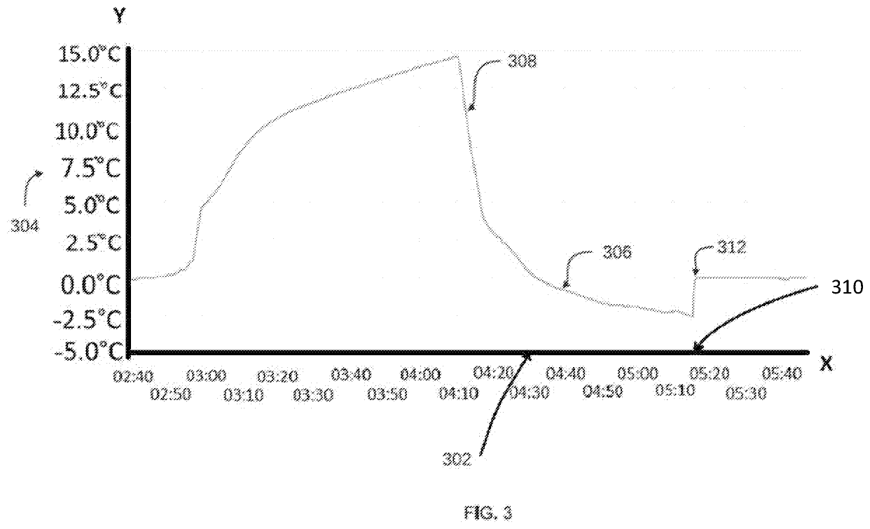

By comparing the graph of FIG. 2 to a graph showing a temperature of a phase change material (PCM) over time when the PCM does have a nucleation material added (the graphs of FIGS. 3, 4 and 5), the effect of the nucleation material can be seen.

FIG. 2 is a graph having an X-axis 202 of time (hours) and a Y-axis 204 of temperature in degrees Celsius.

FIG. 2 show a line 206 showing a temperature of water without a nucleation agent over time.

FIG. 2 shows temperature of water being cooled in a container (such as a test tube or capsule or Thermal Storage Unit) that is cooled by a cooling agent such as a chilled mixture of water and glycol. It can be seen that around the time 04:15 (reference 208) the water starts being cooled. The temperature of the water goes down to a temperature of approximately −3 degrees Celsius, at a time of approximately 05:45 (reference 210), after which cooling ends, and the water gradually rises in temperature.

The graph of FIG. 2 was produced to show a cycle of freeze and unfreeze/melting. The cycle started at a melt stage—set to +10.0° C. and after a period of time, when the tested samples reached 10° C., the temperature surrounding the container dropped to −2.0° C. The temperature of −2.0° C. was maintained for a period of time and then lowered in increments of −0.5 degrees Celsius for each stage. The cycle reached a minimum temperature of −4.0° min.

The cooling stages took a combined total of 1.5 hours and the melting time also took 1.5hours.

The cycle shown in FIG. 2 can be changed according to desired test targets based on a desired cycle gain and/or energy measurement, and so on.

Reference is now made to FIG. 3, which is a graph showing a temperature of a PCM, in this example water, over time, when the PCM does have a nucleation agent, in this example a Polyamide (PA) polymer, added, according to an example embodiment.

By comparing the graph of FIG. 2 to the graph of FIG. 3, the effect of the nucleation material can be seen.

FIG. 3 is a graph having an X-axis 302 of time (hours) and a Y-axis 304 of temperature in degrees Celsius.

FIG. 3 shows a line 306 showing a temperature, over time, of water which is mixed with a nucleation agent.

FIG. 3 shows that around the time 04:15 (reference 308) the water starts being cooled. The temperature of the water goes down to a temperature of approximately −2.5 degrees Celsius, at a time of approximately 05:15 (reference 310), at which time the water freezes (reference 312).

The freezing releases heat, which brings the temperature to 0 degrees Celsius, which is the temperature of water icing. It is noted that not all the water has necessarily been frozen at this time, there may be a mix of water and ice (and the nucleation agent).

FIG. 3 shows that after at least some of the water started to freeze (reference 312) the temperature remains at 0 degrees Celsius.

In some embodiments the cooling may continue, freezing more and more water into ice.

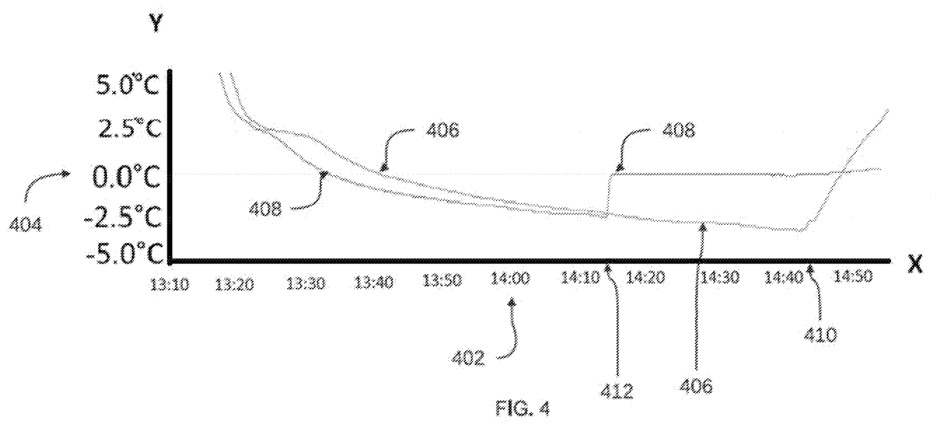

Reference is now made to FIG. 4, which is a graph showing a comparison of temperature, over time, of water with a nucleation agent added to water without nucleation agent added, according to an example embodiment.

FIG. 4 compares the behavior of two materials, a first material, water without the nucleation material, and a second material, water which is mixed with a nucleation agent, under cooling and freezing.

FIG. 4 is a graph having an X-axis 402 of time (hours) and a Y-axis 404 of temperature in degrees Celsius.

FIG. 4 show a first line 406 showing a temperature of a first material, water without the nucleation material, and a second line 408 showing a temperature of a second material, water which is mixed with a nucleation agent, over time.

At approximately 13:20 both the first material and the second material, were being cooled, and their temperature dropped over time. The cooling was performed by similar systems, at similar power settings, cooling similar volumes of the two materials, contained in similar containers.

The first material, depicted by the first line 406, was cooled until approximately 14:42(reference 410), and its temperature continued to drop, reaching a minimum of approximately −3 degrees Celsius. At approximately 14:42 (reference 410) the cooling stopped, and the first material gradually warmed back up.

The second material, depicted by the second line 408, was cooled until at approximately 14:15 (reference 412), the second material froze, and its temperature rose to the temperature of water icing, approximately 0 degrees Celsius. The cooling continued until approximately 14:42 (reference 410), freezing more water into ice, without the temperature of the ice and water mixture changing much. At approximately 14:42 (reference 410), the cooling stopped, but the temperature of the second material remained at approximately 0 degrees Celsius. Heat absorbed by the second material melted some of the ice of the water-and-ice mixture back into water, but the temperature of the water-and-ice mixture remained at approximately 0 degrees Celsius as long as there was some ice in the mixture. When all or most of the ice melts, the temperature of the second material also raises.

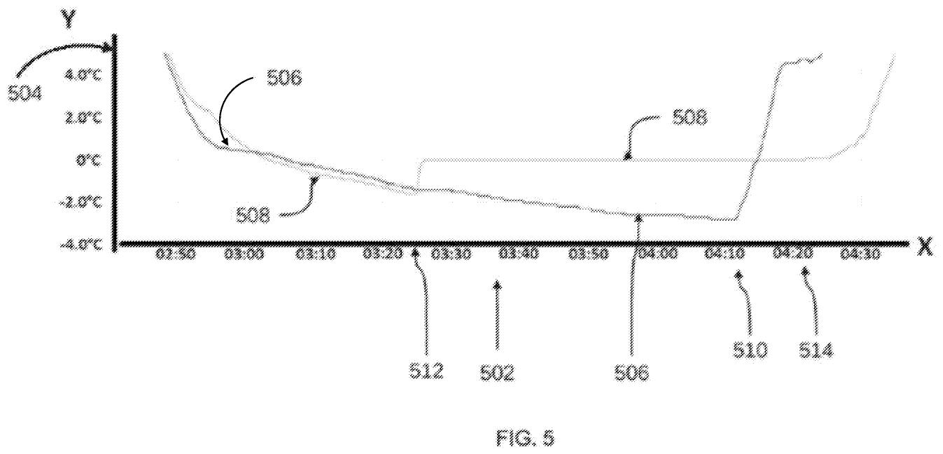

Reference is now made to FIG. 5, which is a graph showing a comparison, over time, of temperature of water with a nucleation agent added to water without a nucleation agent added, according to an example embodiment.

FIG. 5 compares the behavior of two materials, a first material, water without the nucleation material, and a second material, water which is mixed with a nucleation agent, under cooling and freezing.

FIG. 5 is a graph having an X-axis 502 of time (hours) and a Y-axis 504 of temperature in degrees Celsius.

FIG. 5 show a first line 506 showing a temperature of a first material, water without the nucleation material, and a second line 508 showing a temperature of a second material, water which is mixed with a nucleation agent, over time.

At approximately 02:50 both the first material and the second material, were being cooled, and their temperature dropped over time. The cooling was performed by identical systems, at identical power settings, cooling identical volumes of the two materials, contained in identical containers.

The first material, depicted by the first line 506, was cooled until approximately 04:12 (reference 510), and its temperature continued to drop, reaching a minimum of approximately −3 degrees Celsius. At approximately 04:12 (reference 510) the cooling stopped, and the first material gradually warmed back up.

The second material, depicted by the second line 508, was cooled until at approximately 03:25 (reference 512), the second material froze, and its temperature rose to the temperature of icing, approximately 0 degrees Celsius. The cooling continued until approximately 04:12 (reference 510), freezing more water into ice, without the temperature of the ice and water mixture changing much. At approximately 04:12 (reference 510), the cooling stopped, but the temperature of the second material remained at approximately 0 degrees Celsius until approximately 04:22 (reference 514). Heat absorbed by the second material melted some of the ice of the water-and-ice mixture back into water, but the temperature of the water-and-ice mixture remained at approximately 0 degrees Celsius. After 04:22 (reference 514) the second material is mostly unfrozen, and the temperature of the second material rises.

### Example Embodiments of Nucleation Materials

The above-mentioned list of desirable properties of which one or more properties may belong to embodiments of nucleation materials is now summarized:
the nucleation material potentially withstands multiple cycles of phase change without significantly degrading its capability of raising the nucleating temperature of the PCM; and the nucleation material can potentially absorb and/or adsorb PCM, or be absorbed by the PCM.

Some non-limiting examples of nucleation materials possessing at least some of the properties described above is a group of materials named nylon, for example Polyamide (PA) polymers.

Some PA polymers useful as nucleating agents include Nylon 6, for example,

PA6 and/or PA66 and/or PA6/6 and/or PA6/9 and/or PA6/10 and/or PA6/11 and/or PA6/12 and/or PA101 and/or PA10/12 and/or PA510 and/or PA46 and/or PA12; and/or other nylon types.

The above-mentioned polymers have a water absorption ability which enables the nucleation to occur.

In some embodiments, the nucleation material includes a mix of the above-mentioned PA polymers.

In some embodiments the nucleation material includes a mix of one or more of the above-mentioned PA polymers, plus one or more additional mineral(s).

In some embodiments the nucleation material includes a mix of one or more of the above-mentioned PA polymers, plus, by way of a non-limiting example, quartz.

### Example Embodiments of Physical State of the Nucleation Materials

In some embodiments, the nucleation material used is chosen to have a fine grain size, such as a powder.

In some embodiments, the nucleation material may have a grain size in a range of 0.01 millimeters to 1.5 millimeters, and possibly up to 5.0 millimeters in diameter.

In some embodiments, a nucleation material is ground to a granular nucleation material having a fine grain size. In some embodiments the granular nucleation material is passed through a sieve so as to maintain a grain size no greater than a specific desired maximum, e.g., 1.5 mm.

In some embodiments the nucleation material is chosen to have a rough and irregular shape, which potentially increase its efficacy, that is, the temperature by which it raises the nucleation point of a PCM and nucleation agent combination.

In some embodiments PA is ground to obtain grains of nucleating agent.

In some embodiments, the rough shape is obtained by grinding the nucleation material without subsequent smoothing of the ground particles.

In some embodiments, the nucleation material used is chosen to be in a form of filaments and/or thin threads, by way of some non-limiting examples, PA threads suspended, a pad of PA threads, a web of PA threads, and a tangle of PA threads.

In some embodiments, the nucleation material used is chosen to be in a form of a porous material, by way of a non-limiting example, a PA sponge. In some embodiments, the nucleation material is added to PCM, for example added to water.

In some embodiments, PCM such as water is added to the nucleation material.

In some embodiments, a PCM and nucleation combination, for example a water and PA polymer combination is allowed time for the nucleation agent to absorb the PCM.

In some embodiments, a PCM and nucleation combination, for example a water and PA polymer combination is allowed time for the nucleation agent to absorb the PCM, after which the nucleation agent sinks to the bottom of the container of the PCM.

In some embodiments, a PCM and nucleation combination, for example a water and PA polymer combination is shaken or stirred before cooling.

### Example Embodiments of Concentration of Nucleation Material(s) (NM) in PCM and NM mix

In some embodiments, a PA polymer is mixed with water at a concentration in a range between 0.5 and 25 grams of the nucleation material per 2 liters of water.

### Example Embodiments of Thermal Storage Units

In some embodiments, the PCM and nucleation material are contained in a Thermal Storage Unit (TSU).

In some embodiments, the TSU includes thermal storage capsules within the TSU, and the PCM and nucleation material are contained in the thermal storage capsules.

In some embodiment the TSU is designed so that a heat exchange fluid (such as a mixture of water and glycol) flows around the thermal storage capsules.

In some embodiments, the TSU is an ice-on-coil TSU, and the PCM and nucleation agent are contained in the TSU, and a fluid conduit “coil” contains flow of heat exchange fluid for heat exchange with the PCM and nucleation agent.

In some embodiments, the nucleation agent is optionally provided as a sponge or as a web, arranged so as not to come into contact with the fluid conduit “coil” of the TSU.

### Some Technical Notes

In some embodiments, the nucleating material takes some time to achieve a full effect of a maximal raising of nucleating temperature. The nucleating material may become more effective as it absorbs water, and maximally effective when it reaches a limit of its water absorption capability.

### Some Non-Limiting Example Uses of Raising a Freezing Temperature of a PCM

In some embodiments the nucleating material is used for nucleation when freezing water, for example, in Thermal Storage Units, in snow guns, in ice arenas such as for ice skating, and additional applications.

In some embodiments the nucleating material is used in a thermal energy storage system, and potentially raises the nucleation temperature of water used in a thermal storage unit, and/or in sealed capsules within a thermal storage unit.

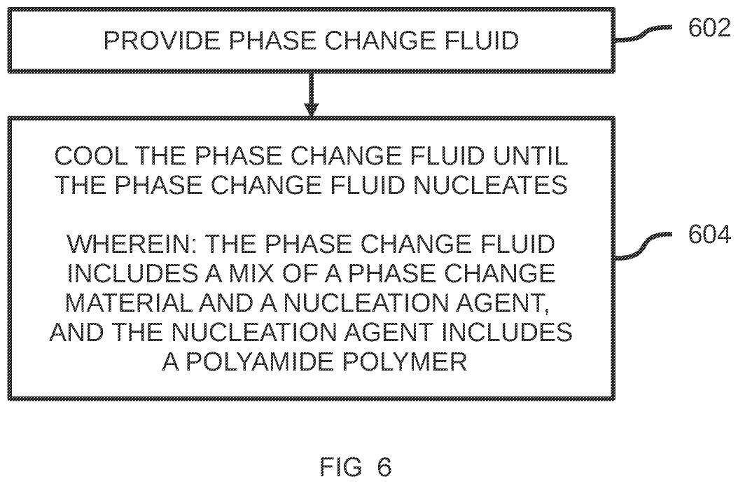

Reference is now made to FIG. 6, which is a simplified flowchart illustration of a method of freezing phase change fluid according to an example embodiment.

The method of FIG. 6 includes:
providing a phase change fluid (602); and
cooling the phase change fluid until the phase change fluid nucleates, wherein:
the phase change fluid comprises a mix of a phase change material and a nucleation agent, and
the nucleation agent comprises a Polyamide (PA) polymer.

It is expected that during the life of a patent maturing from this application many relevant nucleation materials will be developed and the scope of the term nucleation material is intended to include all such new technologies a priori.

It is expected that during the life of a patent maturing from this application many relevant phase changes materials will be developed and the scope of the term phase changes material is intended to include all such new technologies a priori.

The terms “comprising”, “including”, “having” and their conjugates mean “including but not limited to”.

The term “consisting of” is intended to mean “including and limited to”.

The term “consisting essentially of” means that the composition, method or structure may include additional ingredients, steps and/or parts, but only if the additional ingredients, steps and/or parts do not materially alter the basic and novel characteristics of the claimed composition, method or structure.

As used herein, the singular form “a”, “an” and “the” include plural references unless the context clearly dictates otherwise. For example, the term “a unit” or “at least one unit” may include a plurality of units, including combinations thereof.

The words “example” and “exemplary” are used herein to mean “serving as an example, instance or illustration”. Any embodiment described as an “example or “exemplary” is not necessarily to be construed as preferred or advantageous over other embodiments and/or to exclude the incorporation of features from other embodiments.

The word “optionally” is used herein to mean “is provided in some embodiments and not provided in other embodiments”. Any particular embodiment of the invention may include a plurality of “optional” features unless such features conflict.

Throughout this application, various embodiments of this invention may be presented in a range format. It should be understood that the description in range format is merely for convenience and brevity and should not be construed as an inflexible limitation on the scope of the invention. Accordingly, the description of a range should be considered to have specifically disclosed all the possible sub-ranges as well as individual numerical values within that range. For example, description of a range such as from 1 to 6 should be considered to have specifically disclosed sub-ranges such as from 1 to 3, from 1 to 4, from 1 to 5, from 2 to 4, from 2 to 6, from 3 to 6 etc., as well as individual numbers within that range, for example, 1, 2, 3, 4, 5, and 6. This applies regardless of the breadth of the range.

Whenever a numerical range is indicated herein (for example “10-15”, “10 to 15”, or any pair of numbers linked by these another such range indication), it is meant to include any number (fractional or integral) within the indicated range limits, including the range limits, unless the context clearly dictates otherwise. The phrases “range/ranging/ranges between” a first indicate number and a second indicate number and “range/ranging/ranges from” a first indicate number “to”, “up to”, “until” or “through” (or another such range-indicating term) a second indicate number are used herein interchangeably and are meant to include the first and second indicated numbers and all the fractional and integral numbers therebetween.

Unless otherwise indicated, numbers used herein and any number ranges based thereon are approximations within the accuracy of reasonable measurement and rounding errors as understood by persons skilled in the art.

It is appreciated that certain features of the invention, which are, for clarity, described in the context of separate embodiments, may also be provided in combination in a single embodiment. Conversely, various features of the invention, which are, for brevity, described in the context of a single embodiment, may also be provided separately or in any suitable sub-combination or as suitable in any other described embodiment of the invention. Certain features described in the context of various embodiments are not to be considered essential features of those embodiments, unless the embodiment is inoperative without those elements.

Although the invention has been described in conjunction with specific embodiments thereof, it is evident that many alternatives, modifications and variations will be apparent to those skilled in the art. Accordingly, it is intended to embrace all such alternatives, modifications and variations that fall within the spirit and broad scope of the appended claims.

All publications, patents and patent applications mentioned in this specification are herein incorporated in their entirety by reference into the specification, to the same extent as if each individual publication, patent or patent application was specifically and individually indicated to be incorporated herein by reference. In addition, citation or identification of any reference in this application shall not be construed as an admission that such reference is available as prior art to the present invention. To the extent that section headings are used, they should not be construed as necessarily limiting.

In addition, any priority document(s) of this application is/are hereby incorporated herein by reference in its/their entirety.

1. A unit comprising:
a Phase Change Material (PCM); and
a nucleating temperature elevating nucleation agent in contact with the PCM,
wherein the nucleation agent comprises a Polyamide (PA) polymer.

2. The unit according to claim 1, configured to be a thermal energy storage.

3. The unit according to claim 1, wherein the PCM comprises water.

4. The unit according to claim 1, wherein the nucleation agent comprises a granulated Polyamide (PA) polymer.

5. The unit according to claim 4, wherein the granulated Polyamide (PA) polymer has a grain size of up to 5 millimeters in diameter.

6. The unit according to claim 4, wherein the granulated Polyamide (PA) polymer has a grain size of between 0.01 and 1.5 millimeters in diameter.

7. The unit according to claim 1, wherein the nucleation agent comprises a Polyamide (PA) polymer filament.

8. The unit according to claim 1, wherein the nucleation agent comprises a tangled filament.

9. The unit according to claim 1, wherein the nucleation agent comprises a Polyamide (PA) polymer sponge.

10. The unit according to claim 1, comprising a capsule, the capsule comprising the PCM and the nucleation agent.

11. A method of freezing phase change fluid, the method comprising:
providing a phase change fluid; and
cooling the phase change fluid until the phase change fluid nucleates,
wherein:
the phase change fluid comprises a mix of a phase change material (PCM) and a
a Polyamide (PA) polymer.

12. The method according to claim 11 wherein the PCM comprises water.

13. The method according to claim 11 wherein the nucleating agent is ground PA.

14. The method according to claim 13 wherein the ground PA comprises a grain size of up to 5 mm.

15. A method of producing phase change fluid, the method comprising:
adding a Polyamide (PA) polymer to the water, a fluid, to produce an elevated nucleation temperature mixture with a nucleation temperature higher than the nucleation temperature of the fluid without the PA polymer.

16. The method according to claim 15 wherein the fluid comprises water.

17. The method according to claim 15 wherein the fluid is provided to a capsule for use in a Thermal Storage Unit (TSU) and the (PA) polymer is added to the capsule.

18. The method according to claim 15, comprising mixing the fluid and the PA polymer.

19. The method according to claim 15, wherein the PA polymer is granulated PA polymer material.

20. The method according to claim 19, wherein grains of the granulated PA polymer material have a grain size of up to 5 millimeters in diameter.
